(19) United States
(12) Patent Application Publication
(10) Pub. No.: US 2001/0035105 A1
(43) Pub. Date: Nov. 1, 2001

(54) Lithographic plate materials and method for making lithographic plates using the same

(75) Inventors: Toshimichi Katsuoka, Tokyo (JP); Junichi Nouda, Tokyo (JP); Hironori Sato, Ohmiya-shi (JP)

Correspondence Address: LORUSSO & LOUD, 3137 Mt. Vernon Avenue, Alexandria, VA, 22305, US

(73) Assignee: KIMOTO CO., LTD.

(21) Appl. No.: 09/814,112

(22) Filed: Mar. 22, 2001

(30) Foreign Application Priority Data
Mar. 23, 2000 (JP) 2000-82205

(51) Int. Cl. B41N 1/00; B41N 3/00

(52) U.S. Cl. 101/453; 101/465

(57) ABSTRACT

There is provided a lithographic plate material which can be desensitized by distilled water or a fountain solution used for other lithographic plates without desensitizing process using an etching solution and lowers generation of scumming in non-image portion of printed matters. The lithographic plate material has an image-receptive layer formed on a support consisting of at least polyvinyl alcohol cross-linked by tetra alkoxy silane hydrolysate, titanium oxide micropatricles, silica having an average particle size of not less than 1 nm and less than 100 nm. The image-receptive layer has a surface having an arithmetic mean roughness of not less than 0.40 μm and less than 1.20 μm and a contact angle of less than 50 degree to distilled water at room temperature, and is ink-receptive for hot-melt and lipophilic ink.

### BACKGROUND OF THE INVENTION

1. Field of the Invention

The present invention relates to a lithographic plate material with an image-receptive layer capable of providing water retention characteristics for a fountain solution of lithographic printing without desensitizing process. In particular, it relates to a lithographic plate material capable of forming lipophilic images by ink-jet printer using hot-melt type solid ink.

2. Related Art

Lithographic printing using a lithographic printing plate is widely known for making a small amount of printed matters less than ten thousands. Conventionally, the lithographic printing plates are made by forming an image-receptive layer on a substrate such as a waterproof paper and printing lipophilic images on the image-receptive layer using typewriters or making a copy of an original block copy using a dry elecrophotography copier on the image-receptive layer to form lipophilic images of toner.

With the recent development of computers and peripheral devices, plate making processes using various kinds of digital printers are proposed. For example, Japanese patent application laid-open Nos.6-138719 (94), 6-250424 (94) and 7-1847 (95) disclose methods for making a lithographic printing plate by forming toner images on an image-receptive layer using a dry-type electrophotography laser printer.

The inventions disclosed in the aforementioned patent applications are directed to reduce scumming in non-image portion of a printed matter, which is likely to occur when dry-type electrophotography laser printers are used, and to obtain a lithographic plate having excellent plate wear.

Japanese patent application laid-open No.9-58144 (97) discloses a method of making a lithographic plate which does not use the dry-type electrophotography laser printer having such a drawback but forms lipophilic images on an image-receptive layer by an ink-jet printer using a hot-melt type solid ink.

However, the image-receptive layer of the lithographic plate disclosed in the above-mentioned patent application contains zinc oxide and a polymer binder as inevitable components and, therefore, it is necessary to sufficiently desensitize the zinc oxide at the surface of the image-receptive layer in order to impart sufficient water retention characteristics for a fountain solution of lithography to the image-receptive layer by means of etching process using a cyan-system etching solution containing phosphoric acid/potassium ferricyanide as a main component or non-cyan system etching solution containing phytic acid as a main component.

Despite efforts of improving image-receptive layers or printing methods using digital printers to reduce generation of scumming in non-image part of printed matters, insufficient desensitization can be occurred in plate making process due to degradation of the aforementioned etching solution, lowering of the liquid temperature and, as a result, scumming is generated in printed matters.

In addition, a printing process using the lithographic plate according to the invention recited in the above-mentioned application requires a special fountain solution containing components similar to those of the etching solution. As a result, when the plate is used together with another lithographic plate such as an aluminum graining presensitized (PS) plate and/or lithographic plate made by a silver salt diffusion transfer process, a fountain solution set in a lithographic press has to be changed. This makes printing works problematic.

The present invention aims at solving the abovementioned problems. Specifically, an object of the present invention is to provide a lithographic plate material which can be desensitized by distilled water or a fountain solution used for other lithographic plates without desensitizing process using an etching solution and, to reduce scumming in non-image portion of printed matters. Another object of the present invention is to provide a method of making a lithographic plate using the material.

### SUMMARY OF THE INVENTION

A lithographic plate material of the present invention comprises a support and an image-receptive layer formed on the support, wherein the surface of the image-receptive layer has an arithmetic mean roughness defined by JIS(Japanese Industrial Standard)-B0601 of not less than 0.40 μm and less than 1.20 μm and a contact angle to a distilled water at room temperature of less than 50 degree, and the image-receptive layer has ink-receptiveness for hot-melt and lipophilic ink.

A lithographic plate material of the present invention has an image-receptive layer consisting of at least a hydrophilic polymer binder and inorganic microparticles.

A lithographic plate material of the present invention has an image-receptive layer comprising polyvinyl alcohol cross-linked by hydrolysate of tetra-alkoxy silane, titanium oxide microparticles, and silica having an average primary particle size of from 1 nm to 100 nm and/or alumina having an average primary particle size of from 1 nm to 100 nm.

A lithographic plate material of the present invention further comprises an undercoat layer between the support and the image-receptive layer. In this lithographic plate material, the undercoat layer may contain inorganic microparticles or synthetic resin microparticles.

A method of making a lithographic plate of the present invention comprises forming lipophilic images on the image-receptive layer of the lithographic plate material using hot-melt and lipophilic ink.

A method of making a lithographic plate of the present invention further comprises imparting water retention characteristics for a lithographic fountain solution to the surface of the image-receptive layer without desensitizing process.

A method of making a lithographic plate of the present invention comprises forming lipophilic images on the image-receptive layer by an ink-jet printer using hot-melt solid ink.

### PREFERRED EMBODIMENT OF THE INVENTION

Preferred embodiments of the present invention will be explained in detail hereinafter. In the following explanation, “part” and “%” are used on a weight basis unless otherwise indicated.

A lithographic plate material of the present invention comprises a support and an image-receptive layer formed on the support.

As the support, a plastic film composed of a resin such as polyethylene, polypropylene, polyvinylchloride, polystyrene, polyethylene-terephthalate, waterproof paper having such a plastic film laminated thereon or waterproof paper coated with such a resin can be used.

A polyethylene-terephthalate film is particularly preferable in the light of its mechanical strength, dimensional stability, resistance to chemicals, and waterproof property. The support may include light-shielding pigment such as carbon black and titanium oxide in order to obtain light-shielding property. The thickness of the support may be not less than 50 μm and less than 300 μm.

In order to improve adhesive to the image-receptive layer, the support is preferably exposed to far ultraviolet rays, or subjected to a plasma process, colona discharge process or, preferably undercoating process.

Materials of the undercoat depend on a kind of the employed support. When polyethylene-terephthalate film is employed, it may be formed by applying a coating solution containing isocyanate prepolymer dissolved in a resin selected from acetal resins such as polyvinylbutyral, polyester resins having a hydroxyl group at the end of its molecular chain and acrylic copolymers having a hydroxyl group at the end of its side chain to the support so that the undercoat has a dry thickness of not less than 0.5 μm and less than 10 μm.

Besides the purpose of improving of adhesiveness between the support and the image-receptive layer, in order to adjust the surface roughness of the image-receptive layer to be laminated thereon, the undercoat may contain inorganic microparticles such as calcium carbonate, barium sulfate, silica, zincoxide, titanium oxide, clay, alumina or synthetic resin microparticles such as acrylic resin, epoxy resin, nylon resin, polyethylene resin, fluorine resin, benzoguanamine in an amount of not less than 5 parts and less than 200 parts based on 100 parts of the binder resin of the undercoat.

In this range, the surface of the undercoat can be roughened without lowering the film strength of the undercoat. This roughed surface affects the surface of the image-receptive layer and gives preferable surface roughness to the surface of the image-receptive layer.

The coating solution for the undercoat can be prepared using, as occasion demands, known means for preparing a dispersion such as a ball mill, sand grinder, attritor, roll mill, high-speed impeller dispersion mixer. The undercoat can be formed by applying the aforementioned coating solution on the support by means of known coating method such as roll coating, bar coating, blade coating and heat drying at a predetermined temperature.

The image-receptive layer prepared on a support is required to have an arithmetic mean surface roughness defined by JIS-B0601 of not less than 0.40 μm and less than 1.20 μm in order to have an ink-receptiveness for hot-melt solid ink. In addition to the surface roughness of the aforementioned range, it is also required to have a contact angle of less than 50 degrees to distilled water at room temperature in order to have water retention characteristics for a fountain solution of lithography. Such an image-receptive layer consists of at least a hydrophilic polymer binder and inorganic microparticles.

Examples of the hydrophilic polymer binder include polyvinyl alcohol, carboxymethyl cellulose, hydroxyethyl cellulose, polyvinylpyrrolidone, methylvinyl ether/maleic anhydride copolymer. Completely saponified polyvinyl alcohol having a polymerization degree of less than 1000 and a saponification degree of 97 mol % or more is preferred since inorganic microparticles can be dispersed therein very well during preparing the coating solution of the image-receptive layer and it has a cross-linkable property by a tetra alkoxy silane hydrolysate, which will be explained hereinafter.

The tetra alkoxy silane used in the present invention can be obtained by allowing silane tetra chloride, which is a reaction product of metal silicon (a reduction product of silica) and chlorine, to react with alcohol. The tetra alkoxy silane is further hydrolyzed in a mixture of water and alcohol, such as ethanol, isopropanol, and ethyl cellosolve in the presence of acidified catalyst with HCl to provide hydrolysate.

The tetra alkoxy silane hydrolysate functions as a crosslinker of polyvinyl alcohol contained in the image-receptive layer by a silanol group included in its molecule and thereby enables to provide the image-receptive layer having waterproof and water retention characteristics.

An amount of the tetra alkoxy silane hydrolysate added to polyvinyl alcohol is preferably 20 parts or more and less than 200 parts based on 100 parts of polyvinyl alcohol in terms of an amount of tetra alkoxy silane before hydrolysis. With an amount of 20 parts or more, excellent waterproof property can be obtained. With an amount of less than 200 parts, degradation of water retention characteristics for a fountain solution of lithography can be prevented and generation of scumming in non-image part of printed matters can be reduced.

In order to further improve water retention and water proof characteristics and mechanical strength, water soluble resins such as carboxymethyl cellulose, hydroxyethyl cellulose, polyvinylpyrrolidone, and methylvinylether/maleicanhydride copolymer, and emulsion of homopolymers or copolymers of vinyl chloride, vinyl acetate, acrylic ester, ethylene, styrene and the like can be added to polyvinyl alcohol in an amount of less than 30 parts based on 100 parts of polyvinyl alcohol.

With an amount less than 30 parts, water retention and water proof characteristics and mechanical strength can be improved without impairing characteristics of polyvinyl alcohol. The aforementioned emulsion can be a complex with colloidal silica and like so as to further improve the water retention and water proof characteristics and mechanical strength of the image-receptive layer.

Examples of inorganic microparticles used in the present invention include calcium carbonate, barium sulfate, silica, titanium oxide, clay, alumina and the like. In order to impart ink-receptiveness for hot-melt and lipophilic ink, water retention characteristics and mechanical strength to the image-receptive layer, it is preferred to use a combination of titanium-oxide microparticles and silica having a primary particle size of not less than 1 nm and less than 100 nm and/or alumina having a primary particle size of not less than 1 nm and less than 100 nm, which have good adhesiveness to hot-melt and lipophilic ink, show good water retention between molecules and are excellent in mechanical strength.

The titanium-oxide microparticles are prepared by the sulfuric-acid method or chlorine method. The crystalline form may be a rutile form or anatase form. An average particle size may be not less than 0.05 μm and less than 1.0 μm. The surface of particles may be processed with alumina or silica to become hydrophilic.

An amount of the titanium oxide is 50 parts or more, preferably 100 parts or more parts and less than 1000 parts, preferably less than 800 parts based on 100 parts of a polymer binder included in the image-receptive layer.

With these ranges of average particle size and amount, the image-receptive layer can have an arithmetic mean surface roughness defined by JIS-B0601 of 0.40 μm or more and less than 1.20 μm and obtain ink-receptiveness for hot-melt and lipophilic ink, water retention characteristics for a fountain solution, water proof property and mechanical strength.

Silica having a primary particle size of not less than 1 nm and less than 100 nm is anhydrous silica prepared by dry process, which has a hydrophilic surface with many silanol groups. The lower limit of the primary particle size is 1 nm, preferably 5 nm, more preferably 10 nm. The upper limit is 100 nm, preferably 40 nm, more preferably 20 nm. The BET specific surface area is not less than 40 m²/g, preferably not less than 100 m²/g and less than 400 m²/g, preferably less than 300 m²/g.

With these ranges, water retention for a fountain solution of the image-receptive layer can be improved without degrading adhesive property of the image-receptive layer to hot-melt and lipophilic ink. Silica may be a mixed oxide of silica and alumina.

Alumina having a primary particle size of not less than 1 nm and less than 100 nm is prepared by dry process too. The lower limit of the primary particle size is 1 nm, preferably 10 nm. The upper limit is 100 nm, preferably 40 nm. The BET specific surface area is preferably not less than 40 m²/g and less than 200 m²/g.

With this range, adhesive property of the image-receptive layer to hot-melt and lipophilic ink can be improved without degrading water retention property of the image-receptive layer. Silica and alumina may be used alone or as a mixture.

An amount of silica and/or alumina is not less than 2 parts, preferably not less than 5 parts and less than 200 parts, preferably less than 100 parts based on 100 parts of the polymer binder included in the image-receptive layer. With this range of an amount, silica and/or alumina can be dispersed well in a coating solution for the image-receptive layer together with titanium oxide microparticles. Therefore, the coating solution can be applied easily. In addition, the image-receptive layer can have good water retention property, ink-receptiveness for hot-melt and lipophilic ink, waterproof property and mechanical strength.

As occasion demands, the image-receptive layer may contain inorganic microparticles such as calcium carbonate, barium sulfate, clay, silica and alumina having different particle sizes, and the like or synthetic resin microparticles such as acrylic resins, epoxy resins, Nylon, polyethylene resins, fluororesins, benzoguanamine resins in an amount of not more than 100 parts based on 100 parts of the polymer binder included in the image-receptive layer. Silica having an average particle size of not less than 1 μm and less than 10 μm is particularly preferable since it makes fine irregularity on the surface of the image-receptive layer and improves water retention property for a fountain solution without degrading water proof property.

A total amount of titanium oxide microparticles, silica and/or alumina having a primary particle size of not less than 1 nm and less than 100 nm, occasionally added inorganic microparticles and synthetic resin microparticles is not less than 80 parts, preferably not less than 100 parts and less than 1000 parts, preferably less than 800 parts based on 100 parts of the polymer binder included in the image-receptive layer.

If an amount is less than 80 parts, the image-receptive layer cannot have sufficient surface irregularity and therefore lipophilic images formed thereon by hot-melt solid ink cannot adhere the layer and tends to be removed during printing process and disappeared. This results in poor print durability. In addition, the image-receptive layer has insufficient water retention property for a fountain solution, which leads to generation of scumming in non-image part of printed matters.

On the one hand, if an amount is 1000 or more parts, the surface of the image-receptive layer becomes too rough, and ink-receptiveness for lipophilic images by hot-melt solid ink becomes uneven. This results in low resolving power and poor image reproducibility of printed matters. In addition, the film strength of the image-receptive layer is degraded and a part of the layer is removed from the support during printing process. This leads to generation of scumming and poor printing durability.

To form the image-receptive layer of the lithographic plate material of the present invention, an aqueous solution containing not less than 5% and less than 20% of the aforementioned polyvinyl alcohol in distilled water is prepared, and titanium oxide microparticles, silica and/or alumina having a primary particle size of not less than 1 nm and less than 100 nm, occasionally inorganic microparticles and synthetic resin microparticles, water soluble resins, monopolymer or copolymer resin emulsion are mixed therein. Then tetra alkoxy silane is added thereto to obtain a coating solution. The coating solution is applied to a support by means of know coating method such as roll coating, bar coating, blade coating to form a coat layer on the support. The coat layer is dried in an atmosphere of not less than 50° C. and less than 200° C. for 30 seconds to 10 minutes.

Occasionally, the aforementioned coating solution for the image-receptive layer may be prepared using a known means for preparing a dispersion such as a ball mill, sand grinder, attritor, roll mill, high-speed impeller dispersion mixer.

The lithographic plate material of the present invention may be provided with a low electric-resistance layer in an opposite side to the aforementioned image-receptive layer. The low electric-resistance layer helps a static adsorption mechanism of an ink-jet printer using hot-melt solid ink, which will be explained later, and consequently the lithographic plate material of the present invention can be attached to a vertical mounting portion without clamp or adhesive tape. In addition, since the lithographic plate material of the present invention sticks on the mounting portion, flatness of the lithographic plate can be kept without floating, and rubbing of the image receiving surface with a recording head can be prevented.

The low electric-resistance layer consists of an ion conductive acrylic resins obtained by copolymerization of a cation monomer having 4th class ammonium-salt groups such as hydroxy propyltrimethyl ammonium chloride methacrylate and oxyethyl trimethyl ammonium chloride methacrylate, and a lipophilic monomer such as methyl methacrylate and butyl methacrylate.

The surface resistivity of the aforementioned low electric-resistance layer is preferably less than 10¹⁰ Ω. If surface resistivity is 10¹⁰ Ω or more, the static adsorption mechanism does not operate efficiently.

A method of making a lithographic plate of the present invention comprises providing the aforementioned lithographic plate material and forming lipophilic images on the image-receptive layer of the material using hot-melt and lipophilic ink.

To apply the hot-melt and lipophilic ink on the image-receptive layer, ink-jet printers using hot-melt type solid ink can be employed.

The ink-jet printer using hot-melt type solid ink is disclosed in “Electrophotography No.112 pp71-75 (Society of Electrophotography)” and “Japan Hardcopy '99, Literatures pp.347-350 (The Imaging Society of Japan).” The ink-jet printer forms lipophilic images by heating and liquefying solid ink, which is solid at room temperature, and injecting a recording dot toward the image-receptive layer.

The hot-melt type solid ink is composed mainly of a hot-melt compound, i.e. wax, which is solid at room temperature and liquefied by heating. In order to obtain suitable printing characteristics for ink-jet printing, it may further contain resins selected from polyamide resins, polyester resins, polyvinyl acetate resin and the like, and colorant. In addition, acrylate resins, urethane resins and the like may be added to the hot-melt type solid ink so that the ink adheres firmly to the image-receptive layer and mechanical strength such as surface abrasion strength of the lipophilic images, chemical strength such as resistance to printing ink or a fountain solution, and affinity to the printing ink can be kept.

According to the method of making a lithographic plate of the present invention, the surface of the image-receptive layer can be imparted with water retention property using a fountain solution of lithography without desensitizing the layer since it employs the aforementioned lithographic plate material. Consequently, a lithographic plate made from the material can be directly used for a lithographic press. As occasion demands, however, distilled water or a fountain solution of a lithographic press may be applied to the image-receptive layer to prevent the plate surface to be stained.

### EXAMPLES

Hereafter, the present invention will be explained with reference to the following examples.

### Example 1

1. Preparation of coating solution for undercoat layer

| | |
|---|---|
| Polyester resin having hydroxyl groups | 10 parts |
| at molecular ends (Elitel UE3201, | |
| Unichika, Ltd.) | |
| Isocyanate prepolymer | 2 parts |
| (solid content: 60%, Takenate D110N, | |
| Takeda Chemical Industries, Ltd.) | |
| Silica (average particle size: 6 μm, | 1.5 parts |
| Sylysia 770, Fuji-Silysia Chemical | |
| Ltd.,) | |
| Toluene | 50 parts |
| Methyl ethyl ketone | 50 parts |

A mixture of the above materials was stirred for 1 hour to form a coating solution for undercoat layer.

2. Preparation of coating solution for image-receptive layer

| | |
|---|---|
| Titanium oxide microparticles | 30 parts |
| (average particle size: 0.12 μm, | |
| FA55W, FURUKAWA CO., LTD.) | |
| Silica (primary particle size: | 2 parts |
| 12 nm, specific surface area | |
| according to BET method: 200 m²/g, | |
| Aerosil 200, Nippon Aerosil Co., Ltd.) | |
| Alumina (primary particle size: | 1 part |
| 13 nm, specific surface area | |
| according to BET method: 100 m²/g, | |
| Aluminum Oxide C, Degussa-Huels Ltd.) | |
| Polyvinyl alcohol (10% aqueous solution, | 100 parts |
| saponification degree: 98.5 mol % or more, | |
| polymerization degree: less than 1000, | |
| Gosenol NL05, The Nippon Synthetic | |
| Chemical Industry Co., Ltd.) | |
| Isopropyl alcohol | 40 parts |
| Distilled water | 100 parts |

A mixture of the above materials was subjected to dispersion treatment in a ball mill for 3 days.

In an amount of 200 parts of the obtained dispersion was added with the following materials and stirred for 1 hour to prepare a coating solution for image-receptive layer.

| | |
|---|---|
| Silica (average particle size: 6 μm, | 1 part |
| Sylysia 770, Fuji-Silysia Chemical | |
| Ltd.,) | |
| Tetraethoxysilane hydrolysate | 30 parts |

The tetraethoxysilane hydrolysate was obtained by mixing the following materials and allowing hydrolysis reaction at room temperature for 24 hours.

| | |
|---|---|
| Tetraethoxysilane (reagent grade, | 100 parts |
| Wako Pure Chemical Industries, Ltd.) | |
| Ethanol | 100 parts |
| 0.1 N hydrochloric acid | 200 parts |
| aqueous solution | |

3. Preparation of coating solution for low electric-resistance layer

| | |
|---|---|
| Ion-conductive acrylic resin solution | 30 parts |
| (solid content: 35%, Saftomer STH-55, | |
| Mitsubishi Chemical Co.) | |
| Silica (average particle size: 3 μm, | 1 part |
| Sylysia 730, Fuji-Silysia Chemical | |
| Ltd.,) | |
| Isopropyl alcohol | 50 parts |

A mixture of the above materials was stirred for 1 hour to prepare a coating solution for low electric-resistance layer.

A white polyethylene terephthalate film having a thickness of 188 μm was coated with the coating solution for undercoat layer using a Mayer bar and dried with hot air at 100° C. for 2 minutes to form an undercoat layer having a thickness of 5 μm.

Subsequently, the coating solution for image-receptive layer was coated on the undercoat layer in a similar manner, and dried with hot air at 150° C. for 5 minutes to form an image-receptive layer having a thickness of 7 μm.

Further, the coating solution for low electric-resistance layer was coated on the surface opposite to the surface coated with the image-receptive layer in a similar manner, and dried with hot air at 100° C. for 2 minutes to form a low electric-resistance layer having a thickness of 2 μm. Thus, a lithographic plate material according to the present invention was obtained.

The surface of the image-receptive layer of the obtained lithographic plate material of the present invention showed an arithmetic mean roughness defined by JIS-B0601 of 0.9 μm and a contact angle to distilled water of 15° at room temperature. The surface resistivity of the low electric-resistance layer was 0.7×10⁸ Ω.

### Example 2

A lithographic plate material was obtained in the same manner as in Example 1 except that the amount of the silica (primary particle size: 12 nm, specific surface area according to BET method: 200 m²/g) was changed to 3 parts and no alumina was used in the coating solution for image-receptive layer.

The surface of the image-receptive layer of the obtained lithographic plate material showed an arithmetic mean roughness defined by JIS-B0601 of 0.9 μm and a contact angle to distilled water of 15° at room temperature.

### Example 3

A lithographic plate material was obtained in the same manner as in Example 1 except that the silica (primary particle size: 12 nm, specific surface area according to BET method: 200 m²/g) was not added and the amount of alumina was changed to 3 parts in the image-receptive layer.

The surface of the image-receptive layer of the obtained lithographic plate material showed an arithmetic mean roughness defined by JIS-B0601 of 0.9 μm and a contact angle to distilled water of 20° at room temperature.

### Example 4

A lithographic plate material was obtained in the same manner as in Example 1 except that the coating solution for low electric-resistance layer was not coated, i.e., the low electric-resistance layer was not provided.

The surface resistivity of the surface opposite to the image-receptive layer surface was 10¹⁴ Ω or more.

### Comparative Example 1

A lithographic plate material was obtained in the same manner as in Example 1 except that no silica was added in the preparation of the coating solution for undercoat layer and the silica (average particle size: 6 μm) was not added in the preparation of the coating solution for image-receptive layer.

The surface of the image-receptive layer of the obtained lithographic plate material showed an arithmetic mean roughness defined by JIS-B0601 of 0.25 μm and a contact angle to distilled water of 20° at room temperature.

### Comparative Example 2

A lithographic plate material was obtained in the same manner as in Example 1 except that the amount of the silica was changed to 8 parts in the preparation of the coating solution for undercoat layer.

The surface of the image-receptive layer of the obtained lithographic plate material showed an arithmetic mean roughness defined by JIS-B0601 of 1.5 μm and a contact angle to distilled water of less than 10° at room temperature.

### Comparative Example 3

A coating solution for image-receptive layer, which was prepared by subjecting the following materials to dispersion treatment in a ball mill for 3 days, was coated without providing an undercoat layer, and dried with hot air at 120° C. for 2 minutes to provide an image-receptive layer having a thickness of about 9 μm.

A low electric-resistance layer was provided in the same manner as in Example 1 to obtain a lithographic plate material. Preparation of coating solution for image-receptive layer

| | |
|---|---|
| Polyester resin having hydroxyl groups | 5 parts |
| at molecular ends (Elitel UE3201, | |
| Unichika, Ltd.) | |
| Zinc oxide (for wet electrophotography | 30 parts |
| master, Sazex #2000, Sakai Chemical | |
| Industry Co., Ltd.) | |
| Silica (average particle size: 3.0 μm, | 5 parts |
| not subjected to any treatment, | |
| Sylysia 730, Fuji-Silysia Chemical | |
| Ltd.,) | |
| Toluene | 48 parts |
| Methyl ethyl ketone | 12 parts |

The surface of the image-receptive layer of the obtained lithographic plate material showed an arithmetic mean roughness defined by JIS-B0601 of 0.8 μm and a contact angle to distilled water of 65° at room temperature.

The following evaluation was performed for the lithographic plate materials obtained in the above Examples 1-4 and Comparative Examples 1-3.

(1) Evaluation of electrostatic adsorption property of lithographic plate material

The lithographic plate materials obtained in the examples and comparative examples were each attached to an ink-jet printer utilizing hot melt type solid ink (Solid Ink-jet Plate Maker SJ02A, Hitachi Koki Co., Ltd.), and their electrostatic adsorption property was evaluated according to the following criteria. The results are shown in Table 1.

### Evaluation criteria

◯: The lithographic plate material can be attached to a vertical flat mounting portion of the ink-jet printer without using any clamp or adhesive tape, and the material shows close contact with the surface without gap and generates no rubbing at the image-receiving surface with a recording head.

Δ: The lithographic plate material is not dropped off from the mounting portion, but the material partially shows gap, and the recording head rubs the image-receiving surface so that images become partially defective.

X: The lithographic plate material is dropped off from the mounting portion, and therefore the material must be attached by using clamps or adhesive tape.

(2) Evaluation of printability

Printing plates were prepared from the lithographic plate materials obtained in the examples and comparative examples by outputting 4-18 point characters of Mincho typeface and screen tint images with 80 lines of 20%, 40%, 60% and 80% as digital data using an ink-jet printer utilizing hot melt type solid ink (Solid Ink-jet Plate Maker SJ02A, Hitachi Koki Co., Ltd.). Since the lithographic plate material of Example 4 could not be attached to the printer by electrostatic adsorption, the plate making was performed by attaching it to the printer with an adhesive tape.

Printing was performed by using these printing plates under the following printing conditions without subjecting them to desensitization treatment. Then, image reproducibility and scumming of the printed matters were evaluated according to the following criteria (a) and (b). The results are shown in Table 1.

### Printing conditions

Printing machine: SPRINT26, KOMORI CORP.

Printing speed: 9000 sheets/hour

Paper: woodfree sheets

Ink: TK High Echo Sumi M: TOYO INK MFG. CO., LTD.

Fountain solution: PS Etch EU-3, Fuji Photo Film Co., Ltd., diluted 100 times with tap water

(a) Evaluation of image reproducibility of printed matter

### Evaluation criteria

◯: Characters of 4-18 points in Mincho typeface and screen tint images with 80 lines of 20%, 40%, 60% and 80% are resolved and reproduced very well, and no deletion of images is seen even when the number of printed sheets exceeds 5000.

Δ: Characters of 4 point in Mincho typeface and screen tint images with 80 lines of 20% are deleted from the beginning of printing, and resolution reproducibility of characters of 6 point or more in Mincho typeface and screen tint images with 80 lines of 40% or more is degraded and images are partially deleted when the number of printed sheets exceeds 1000.

X: Deletion is observed for characters of 4-18 points in Mincho typeface and the whole area of screen tint images with 80 lines of 20%, 40%, 60% and 80% from the beginning of printing, and thus resolution reproducibility is bad.

(b) Evaluation of scumming

### Evaluation criteria

◯: Scumming is not observed even when the number of printed sheets exceeds 5000.

Δ: Although scumming is not observed at the beginning of printing, scumming is generated in non-image areas and thus printing failure is caused when the number of printed sheets exceeds 1000.

X: Scumming is observed and printing failure is caused even at the beginning of printing.

TABLE 1

| | Electrostatic | | |
|---|---|---|---|
| | adsorption | Image | |
| | property | reproducibility | Scumming |
| Example 1 | ∘ | ∘ | ∘ |
| Example 2 | ∘ | Δ˜∘ | ∘ |
| Example 3 | ∘ | ∘ | Δ˜∘ |
| Example 4 | x | ∘ | ∘ |
| Comparative | ∘ | Δ | Δ |
| Example 1 | | | |
| Comparative | ∘ | x˜Δ | Δ |
| Example 2 | | | |
| Comparative | ∘ | x | x |
| Example 3 | | | |

As seen from the above results, the lithographic plate material of the present invention and the method for making lithographic plate using the same enable use of ink-jet printers utilizing hot melt type solid ink, and can provide lithographic plates in which sufficiently desensitized surfaces can be obtained with distilled water or a fountain solution used for other lithographic plates without desensitization treatment with an etching solution and which do not cause scumming and provide superior printing durability.

1. A lithographic plate material comprising a support and an image-receptive layer formed on the support, wherein the surface of the image-receptive layer has an arithmetic mean roughness defined by JIS-B0601 of not less than 0.40 μm and less than 1.20 μm and a contact angle to distilled water at room temperature of less than 50 degree, and the image-receptive layer has ink-receptiveness for hot-melt and lipophilic ink.

2. A lithographic plate material of claim 1, wherein the image-receptive layer consists of at least a hydrophilic polymer binder and inorganic microparticles.

3. A lithographic plate material of claim 1, wherein the image-receptive layer is composed of at least polyvinyl alcohol cross-linked with tetra-alkoxy silane hydrolysate, titanium oxide microparticles, and silica having an average primary particle size of from 1 nm to 100 nm and/or alumina having an average primary particle size of from 1 nm to 100 nm.

4. A method for making a lithographic plate comprising:
Providing a lithographic plate material having an image-receptive layer formed on a support in which the image-receiving layer has an arithmetic mean surface roughness of not less than 0.40 μm and less than 1.20 μm and a contact angle to distilled water at room temperature of less than 50 degree, and forming lipophilic images on the image-receiving layer using hot-melt and lipophilic ink.

5. A method for making a lithographic plate of claim 4 further comprising imparting water retention characteristics for a fountain solution of lithography to the image-receptive layer without desensitizing process.

6. A method for making a lithographic plate of claim 4, wherein the lipophilic images are formed using an ink-jet printer utilizing hot-melt type solid ink.

7. A lithographic plate material of claim 1 further comprising an undercoat layer between the support and the image-receptive layer.

8. A lithographic plate material of claim 7, wherein the undercoat layer containing inorganic microparticles or synthetic resin microparticles.
